(19) United States
(12) Patent Application Publication
(10) Pub. No.: US 2014/0118394 A1
(43) Pub. Date: May 1, 2014

(54) IMAGE PROCESSING METHOD AND ASSOCIATED APPARATUS

(71) Applicant: MStar Semiconductor, Inc., Hsinchu County (TW)

(72) Inventor: Tun Chieh Yang, Hsinchu County (TW)

(73) Assignee: MStar Semiconductor, Inc., Hsinchu County (TW)

(21) Appl. No.: 14/063,743

(22) Filed: Oct. 25, 2013

Related U.S. Application Data
(60) Provisional application No. 61/718,712, filed on Oct. 26, 2012.

(51) Int. Cl. G06T 3/40; G06T 11/60

(52) U.S. Cl. CPC G06T 3/40; G06T 11/60
USPC 345/629

(57) ABSTRACT

An image processing method is provided. The image processing method, applied to a local computer for processing a first type image having a first size and a second type image having a second size, includes the following steps. The first type image is scaled by a first scaling ratio such that a scaled first type image has a third size. The scaled first type image having the third size is blended with the second type image having the second size. The first type image is received from a remote computer and the second type image is received from the local computer.

This application claims the benefit of U.S. Provisional Patent Application 61/718,712 filed Oct. 26, 2012, the subject matter of which is incorporated herein by reference.

### BACKGROUND OF THE INVENTION

1. Field of the Invention

The invention relates in general to an image processing method and associated apparatus, and more particularly to an image processing method that keeps an image in a local computer unaffected by a process of scaling an image at a remote computer and associated apparatus.

2. Description of the Related Art

The remote control technique is a common technique that allows a user to control a remote computer through a local computer utilized by the user. However, such mechanism encounters several issues when displaying an image. FIG. 1 shows a schematic diagram of an image from a remote computer being scaled jointly with an image at a local computer in the prior art. As shown in FIG. 1, a scaler 101 in a local computer receives a remote image F_{RDP} (e.g., an image corresponding to a remote desktop protocol) from a remote computer 103 and a local image F_{OSD} (e.g., an on-screen display (OSD) image) from a local computer 100. As the scaler 101 scales the remote image F_{RDP}, the local image F_{OSD} is also scaled. Thus, when the local computer 100 scales the remote image F_{RDP} to an appropriate size and displays a remote frame W_{RDP} at a display device 102, a local frame W_{OSD} corresponding to the local image F_{OSD} is also scaled such that the local frame W_{OSD} may be displayed in an inappropriate size.

### SUMMARY OF THE INVENTION

The invention is directed to an image processing method and associated apparatus capable of independently processing a remote image and a local image.

According to an embodiment of the present invention, an image processing method is provided. The image processing method, applied to a local computer for processing a first type image having a first size and a second type image having a second size, comprises: scaling the first type image by a first scaling ratio, such that the scaled first type image has a third size; and blending the scaled first type image with the second type image having the second size. Wherein, the first type image is received from a remote computer and the second type image is received from the local computer.

According to another embodiment of the present invention, an image processing apparatus is provided. The image processing apparatus, applied to a local computer for processing a first type image having a first size and a second type image having a second size, comprises: a scaler, configured to scale the first type image by a first scaling ratio such that the scaled first type image has a third size; and a blender, configured to blend the first type image with the second type image. Wherein, the first type image is received from a remote computer and the second type image is received from the local computer.

According to another embodiment of the present invention, an image processing method is provided. The image processing method, applied to a local computer for processing a first type image having a first size and a second type image having a second size, comprises: scaling the second type image by a first scaling ratio, such that the scaled second type image has a third size; blending the first type image with the scaled second type image to generate a blended image; and scaling the blended image by a second scaling ratio, such that the scaled blended image has a fourth size. Wherein, the first type image is received from a remote computer and the second type image is received from the local computer.

According to yet another embodiment of the present invention, an image processing apparatus is provided. The image processing apparatus, applied to a local computer for processing a first type image having a first size and a second type image having a second size, comprises: a first scaler, configured to scale the second type image by a first scaling ratio, such that the scaled second type image has a third size; a blender, configured to blend the first type image with the scaled second type image to generate a blended image; and a second scaler, configured to scale the blended image by a second scaling ratio, such that the scaled blended image has a fourth size. Wherein, the first type image is received from a remote computer and the second type image is received from the local computer.

Thus, with the method and apparatus of the embodiments, a local image is maintained with a required size when adjusting a remote image, so as to overcome an issue of displaying a local frame in an inappropriate size in the prior art.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of an image from a remote computer being scaled jointly with an image at a local computer in the prior art.

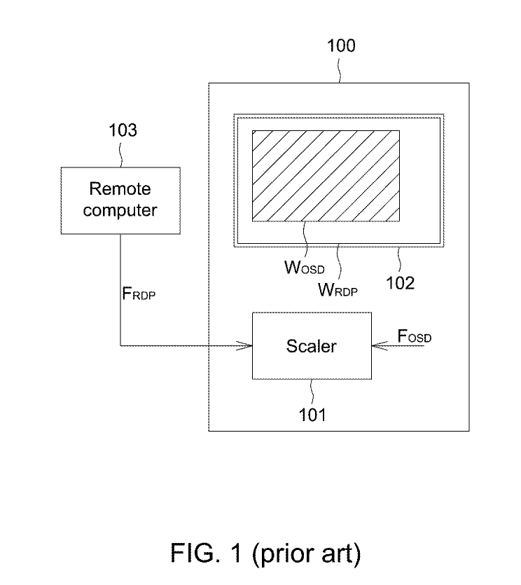

FIG. 2 is an image processing apparatus according to an embodiment of the present invention.

FIG. 3 is a schematic diagram of operations of the embodiment in FIG. 2.

FIGS. 4 and 5 are exemplary extensions of the embodiment in FIG. 2.

FIG. 6 is a data storage method for the embodiment in FIG. 2.

FIG. 7 is an image processing apparatus according to another embodiment of the present invention.

FIG. 8 is a schematic diagram of operations of the embodiment in FIG. 7.

FIG. 9 is a schematic diagram of a local computer implementing an image processing apparatus of the present invention.

FIG. 10 is a flowchart of an image processing method according to an embodiment of the present invention.

FIG. 11 is a flowchart of an image processing method according to another embodiment of the present invention.

### DETAILED DESCRIPTION OF THE INVENTION

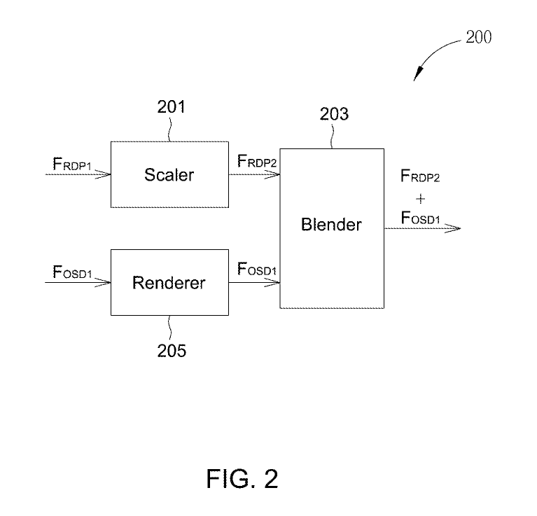

Details of an image processing apparatus and an image processing method according to embodiments of the present invention are described below. FIG. 2 shows an image processing apparatus 200 according to an embodiment of the present invention. As shown in FIG. 2, the image processing apparatus 200 receives a remote computer image F_{RDP1} and a local computer image F_{OSD1}. The original remote computer image F_{RDP1} has a first size, and the local computer image F_{OSD1} has a second size. In the embodiment, for example, the remote computer image F_{RDP1} and the local computer image F_{OSD1} are represented by bitmap files. The image processing apparatus 200 comprises a scaler 201 and a blender 203. The scaler 201 receives the remote computer image F_{RDP1} and scales the remote computer image F_{RDP1} by a first scaling ratio, such that a remote computer image F_{RDP2} after scaling has a third size. The blender 203 blends the scaled remote computer image F_{RDP2} having the third size with the local computer image F_{OSD1} having the second size and outputs a result. In one embodiment, before entering the blender 203, the local computer image F_{OSD1} is first processed by a renderer 205. The renderer 205 performs an appropriate filtering process on the image to facilitate in rendering an image. It should be noted that the renderer 205 is an optional element of the image processing apparatus 200 of the present invention. In an alternative embodiment, the local computer image F_{OSD1} may first be scaled by another scaler before being blended with the remote computer image F_{RDP2}.

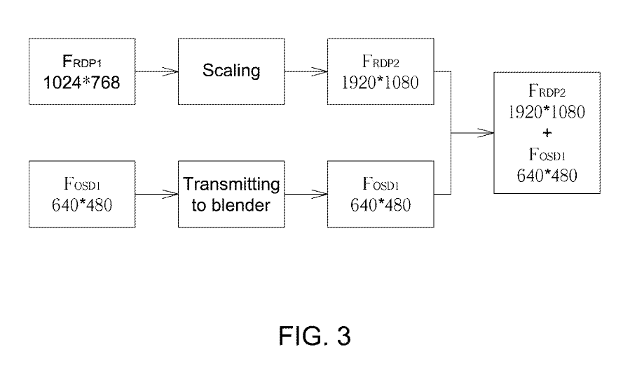

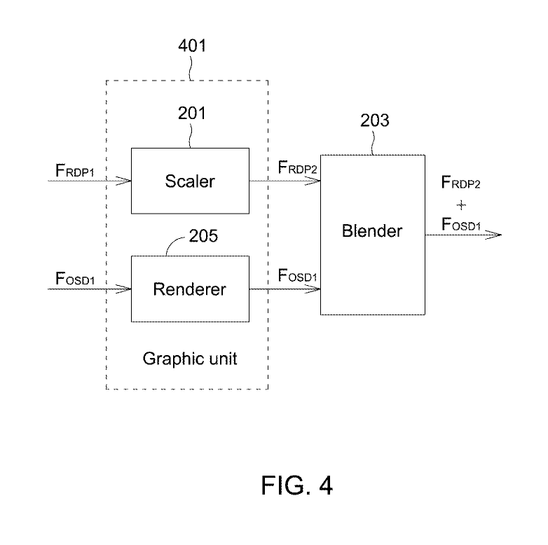

FIG. 3 shows a schematic diagram of operations of the embodiment in FIG. 2. As shown in FIG. 3, the remote computer image F_{RDP1} has 1024×768 pixels (the first size), and the remote computer image F_{RDP2} after scaling has 1920×1080 pixels (the third size); the local computer image F_{OSD1} has 640×480 pixels (the second size). In the embodiment, the third size of the remote computer image F_{RDP2} is the same as the size of a display device of the local computer. Further, the blender 203 adjusts a transparency of the local computer image F_{OSD1} which is blended to the remote computer image F_{RDP2}. In the embodiment in FIG. 2, the scaler 201 and the renderer 205 may be integrated in the same or different graphic units. The graphic units are for generating images according to the remote computer image and/or the local computer image. Taking the embodiment in FIG. 4 for example, the scaler 201 and the renderer 205 are integrated in a same graphic unit 401. In the embodiment in FIG. 5, the scaler 201 and the renderer 205 are respectively integrated in different graphic units 501 and 503.

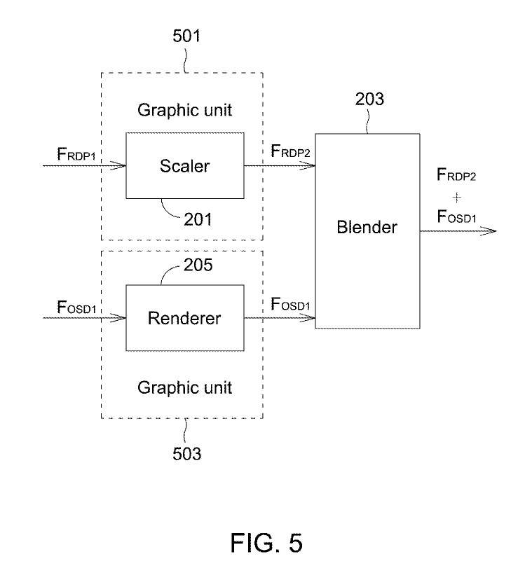

In one embodiment, the blender 203 blends the remote computer image F_{RDP2} having the third size and the local computer image F_{OSD1} having the second size, and outputs the blended remote computer image F_{RDP2} and local computer image F_{OSD1} to a storage device (not shown) and stores the blended remote computer image F_{RDP2} and local computer image F_{OSD1} in the storage device. To display the remote computer image F_{RDP2} or the local computer image F_{OSD1}, the two images are accessed from the storage device. In one embodiment, the remote computer image F_{RDP2} and the local computer image F_{OSD1} are alternately stored. FIG. 6 shows a data storage method of the embodiment in FIG. 2. As shown in FIG. 6, a part of the remote computer image F_{RDP2} is stored at a time point t=N, a part of the local computer image F_{OSD1} is stored at a time point t=N+1, a part of the remote computer image F_{RDP2} is stored at a time point t=N+2, and so forth. It should be noted that, the blended remote computer image F_{RDP2} and local computer image F_{OSD1} are not limited to being outputted to the storage device and stored according to the foregoing method.

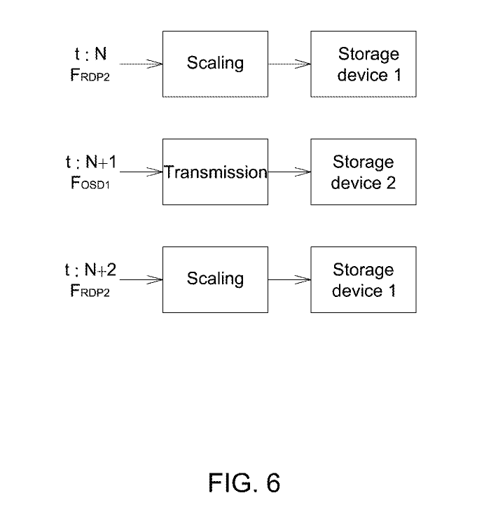

FIG. 7 shows an image processing apparatus according to another embodiment of the present invention. In the embodiment, an image processing 700 comprises two scalers 701 and 705, and a blender 703. The scalers 701 and 705 may be integrated into one scaler. The image processing apparatus 700 receives a remote computer image F_{RDP1} and a local computer image F_{OSD1}. The original remote computer image F_{RDP1} has a first size, and the local computer image F_{OSD1} has a second size. The scaler 701 scales the local computer image F_{OSD1} by a first scaling ratio such that a local computer image F_{OSD2} after scaling has a third size. The blender 703 blends the remote computer image F_{RDP1} with the local computer image F_{OSD2}. The scaler 705 scales the blended remote computer image F_{RDP1} and local computer image F_{OSD2} to generate a scaled blended image having a fourth size. In one embodiment, after the scaling process of the scaler 705, an image within the scaled blended image and corresponding to the remote computer image F_{RDP2} is adjusted to the fourth size; whereas an image within the scaled blended image and corresponding to the local computer image F_{OSD1} is adjusted back to the second size. As such, the remote computer image F_{RDP1} and the local computer image F_{OSD2} can be transmitted in a smaller data amount for saving a bandwidth.

In one embodiment, the image processing apparatus 700 comprises a control unit 707 and a graphic unit 709. The control unit 707 controls operations of the scalers 701 and 705 and the blender 703. The graphic unit 709 generates an image according to the remote computer image F_{RDP1} and the local computer image F_{OSD2}. In the embodiment, for example, the scaler 701 and the blender 703 are integrated in the control unit 707, and the scaler 705 is integrated in the graphic unit 709.

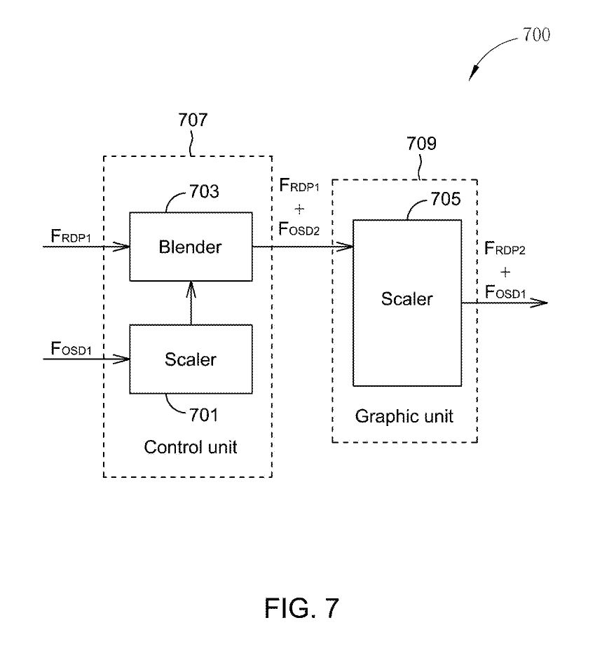

FIG. 8 shows a schematic diagram of operations of the embodiment in FIG. 7. As shown in FIG. 8, the remote computer image F_{RDP1} has 1024×768 pixels (the first size) and the local computer image F_{OSD1} has 640×480 pixels (the second size). After scaling, the local computer image F_{OSD2} has 341×341 pixels (the third size). After blending, the remote computer image F_{RDP1} and the local computer image F_{OSD2} are scaled by the same scaling ratio. Thus, the remote computer image F_{RDP1} becomes a remote computer image F_{RDP2} having 1920×1080 pixels in the blended image, and the local computer image F_{OSD2} is restored to the local computer image F_{OSD1} having 640×480 pixels. In the embodiment, the size of the remote computer image F_{RDP2} is equal to that of the blended image and is the same as that of a display device of the local computer.

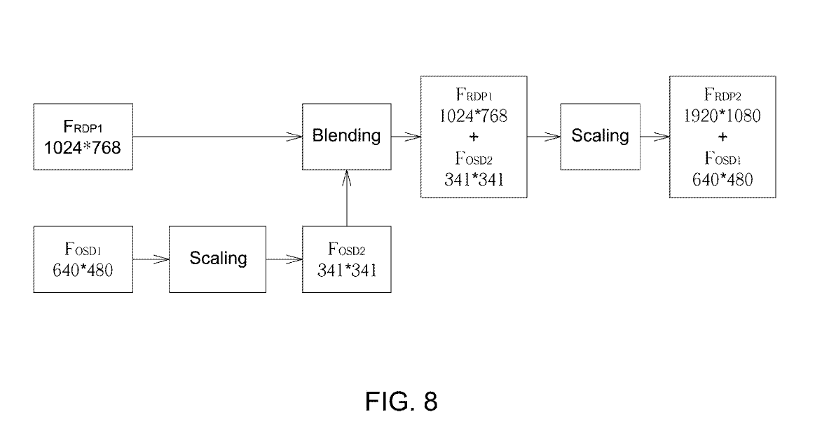

FIG. 9 shows a schematic diagram of a local computer implementing an image processing apparatus of the present invention. As shown in FIG. 9, a local computer 900 comprises an image processing apparatus 901 according to the present invention for processing a remote image F_{RDP} from a remote computer 903 and a local image F_{OSD} from the local computer 901. After being processed by the image processing apparatus 901, a frame W_{RDP} corresponding to the remote image F_{RDP} has a same size as that of a display device 902. Meanwhile, a frame W_{OSD} corresponding to the local image F_{OSD} maintains the original size and is not scaled along with the frame W_{RDP}. Therefore, the foregoing issue of displaying the local image in an inappropriate size is overcomed.

In the above embodiment, the remote image F_{RDP} and the local image F_{OSD} are utilized as examples, and the above embodiment is applicable to any two desired images.

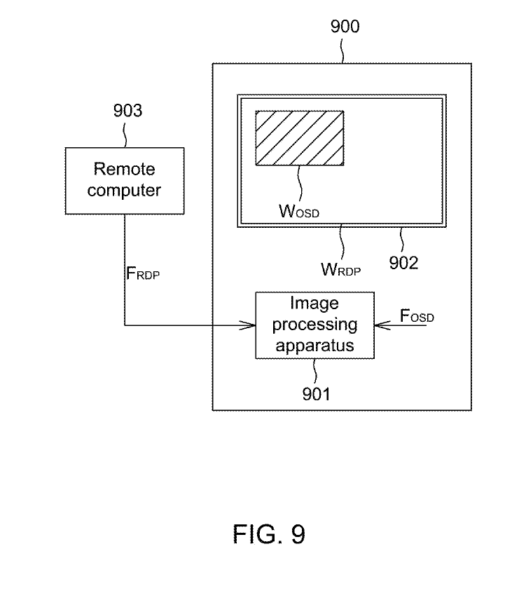

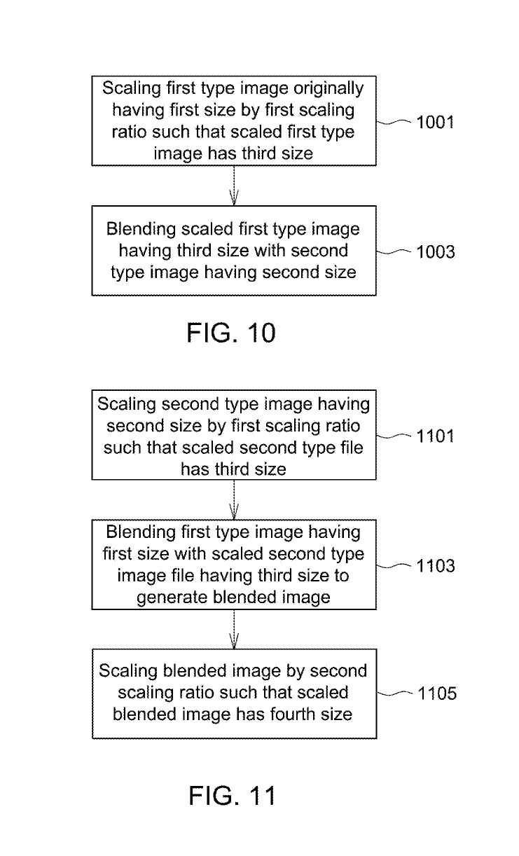

According to the foregoing embodiments, an image processing method as shown in FIGS. 10 and 11 is obtained. FIG. 10 shows a flowchart of an image processing method according to the present invention. The process in FIG. 10 corresponds to the embodiment in FIG. 2 and comprises the following.

In step 1001, a first type image (e.g., F_{RDP1}) originally having a first size is scaled by a first scaling ratio, such that the scaled first type image has a third size (e.g., F_{RDP2}).

In step 1003, the scaled first type image having the third size is blended with a second type image (e.g., F_{OSD1}) having a second size.

FIG. 11 shows a flowchart of an image processing method according to an embodiment of the present invention. The process in FIG. 11 corresponds to the embodiment in FIG. 7 and comprises the following steps.

In step 1101, a second type image (e.g., F_{OSD1}) having a second size is scaled by a first scaling ratio, such that the scaled second type image has a third size (e.g., F_{OSD2}).

In step 1103, a first type image (e.g., F_{RDP1}) having a first size is blended with the scaled second type image (e.g., F_{ODS2}) having the third size to generate a blended image.

In step 1105, the blended image is scaled by a second scaling ratio, such that the scaled blended image has a fourth size. In one embodiment, after the scaling process in the step 1105, an image corresponding to the remote computer image F_{RDP2} within the blended image has the fourth size and an image corresponding to the local computer image F_{OSD1} within the blended image is adjusted back to the second size.

With the foregoing embodiments, a local image can be maintained with a required size when adjusting a remote image, so as to overcome an issue of displaying a local frame in an inappropriate size.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing method, applied to a local computer for processing a first type image having a first size and a second type image having a second size, comprising:
scaling the first type image by a first scaling ratio, such that a scaled first type image has a third size; and
blending the scaled first type image and the second type image;
wherein, the first type image is received from a remote computer and the second type image is received from the local computer.

2. The image processing method according to claim 1, further comprising:
scaling the second type image by a second scaling ratio, such that a scaled second type image has a fourth size;
wherein, the blending step blends the scaled first type image with the scaled second type image.

3. The image processing method according to claim 1, wherein the first type image corresponds to a remote desktop protocol, and the second type image is an on-screen display (OSD) image.

4. The image processing method according to claim 1, wherein the blending step comprises adjusting a transparency of the second type image.

5. The image processing method according to claim 1, wherein before the blending step, the second type image is filtered by a renderer.

6. An image processing method, applied to a local computer for processing a first type image having a first size and a second type image having a second size, comprising:
scaling the second type image by a first scaling ratio, such that a scaled second type image has a third size;
blending the first type image and the scaled second type image to generate a blended image; and
scaling the blended image by a second scaling ratio, such that a scaled blended image has a fourth size;
wherein, the first type image is received from a remote computer and the second type image is received from the local computer.

7. The image processing method according to claim 6, wherein the first type image corresponds to a remote desktop protocol, and the second type image is an on-screen display image.

8. The image processing method according to claim 6, wherein an image within the scaled blended image and corresponding to the scaled second type image is adjusted back to the second size.

9. The image processing method according to claim 6, wherein the blending step comprises adjusting a transparency of the scaled second type image.

10. An image processing apparatus, applied to a local computer for processing a first type image having a first size and a second type image having a second size, comprising:
a scaler, configured to scale the first type image by a first scaling ratio, such that a scaled first type image has a third size; and
a blender, configured to blend the scaled first type image with the second type image;
wherein, the first type image is received from a remote computer and the second type image is received from the local computer.

11. The image processing apparatus according to claim 10, wherein the scaler further scales the second type image by a second scaling ratio, such that a scaled second type image has a fourth size; and the blender blends the scaled first type image with the scaled second type image.

12. The image processing apparatus according to claim 10, wherein the first type image corresponds to a remote desktop protocol, and the second type image is an on-screen display image.

13. The image processing apparatus according to claim 10, wherein the blender further adjusts a transparency of the second type image.

14. The image processing apparatus according to claim 10, further comprises a renderer, configured to filter the second type image before the second type image entering the blender.

15. An image processing apparatus, applied to a local computer for processing a first type image having a first size and a second type image having a second size, comprising:
a first scaler, configured to scale the second type image by a first scaling ratio, such that a scaled second type image has a third size;
a blender, configured to blend the first type image with the scaled second type image to generate a blended image; and
a second scaler, configured to scale the blended image by a second scaling ratio, such that a scaled blended image has a fourth size;
wherein, the first type image is received from a remote computer and the second type image is received from the local computer.

16. The image processing apparatus according to claim 15, wherein the first type image corresponds to a remote desktop protocol, and the second type image is an on-screen display image.

17. The image processing apparatus according to claim 15, wherein the blender further adjusts a transparency of the scaled second type image.

18. The image processing apparatus according to claim 15, further comprising:
a controlling unit, configured to control operations of the first scaler, the second scaler and the blender;
wherein, at least one of the first scaler and the blender is integrated in the controlling unit.

19. The image processing apparatus according to claim 18, further comprising:
a graphic unit, configured to generate an output image according to the blended image;
wherein, the second scaler is integrated in the graphic unit.

20. The image processing apparatus according to claim 15, wherein the first scaler and the second scaler are integrated in a same scaler.

21. The image processing apparatus according to claim 15, wherein an image within the scaled blended image and corresponding to the scaled second type image is adjusted back the second size.
